(19) United States
(12) Patent Application Publication
(10) Pub. No.: US 2011/0279783 A1
(43) Pub. Date: Nov. 17, 2011

(54) OPTICAL ENGINE FOR PROJECTOR

(76) Inventors: Chi-Wei CHANG, Hsinchu City (TW); Wei-Szu Lin, Hsinchu City (TW)

(21) Appl. No.: 13/103,483

(22) Filed: May 9, 2011

(30) Foreign Application Priority Data
May 14, 2010 (TW) 099115450

(51) Int. Cl. G03B 21/16; G03B 21/28

(52) U.S. Cl. 353/52; 353/99

(57) ABSTRACT

An optical engine includes a chassis, a light source module, a light combination module, a light-homogenizing module and a projection lens module. The chassis has different positioning parts, and a part of members of each of the light source module, light combination module, light-homogenizing module, and projection lens module are inserted into a corresponding positioning parts of the chassis to achieve accurate positioning.

### BACKGROUND OF THE INVENTION

a. Field of the Invention

The invention relates to an optical engine for a projector.

b. Description of the Related Art

Nowadays, a handheld projection device continues the trend towards miniaturization. Under the circumstance, except the optical performance, the size of each mechanism inside a projection device should satisfy the requirement of miniaturization. More specifically, moldability and reliability should be taken into consideration in the design of a miniaturized projection device to enhance the compatibility between an optical engine and a mobile phone. FIG. 1 shows a schematic diagram of a conventional miniaturized optical engine for a projector. Referring to FIG. 1, the optical engine 100 is made from Mg—Al alloy and includes a projection lens 102, a digital micromirror device (DMD) 104, a top cover 106, a main body 108 and a light source module 110. Hence, the thickness of the optical engine 100 is formed by a space for light propagation, a thickness of the top cover and a thickness of the bottom cover. As a result, the optical engine 100 fails to be further miniaturized.

FIG. 2 shows a schematic diagram of another conventional miniaturized optical engine for a projector. Referring to FIG. 2, the optical engine 200 uses a design of two-piece main body and includes a projection lens 202, a digital micromirror device (DMD) 204, a top optical engine main body 206, a bottom optical engine main body 208, and a light source module 210. Hence, the thickness of the optical engine 200 is formed by a space of light propagation, a thickness of the top optical engine main body 206 and a thickness of the bottom optical engine main body 206. As a result, the optical engine 200 similarly fails to be further miniaturized. Besides, each of the optical engine 100 and the optical engine 200 has a plenty of components and complicated assembling processes to result in a low production yield.

Hence, it becomes a key issue that how to miniaturize an optical engine for a projector and provide accurate positioning without affecting the optical performance.

### BRIEF SUMMARY OF THE INVENTION

The invention provides a miniaturized optical engine for a projector having at least one advantages of improved production yield, reduced thickness and accurate positioning of components.

Other objects and advantages of the invention may be further illustrated by the technical features broadly embodied and described as follows.

In order to achieve one or a portion of or all of the objects or other objects, one embodiment of the invention provides a miniaturized optical engine for a projector. The optical engine includes a chassis, a light source module, a light combination module, a light-homogenizing module and a projection lens module. The chassis has at least a first positioning part, a second positioning part, a third positioning part and a fourth positioning part. The light source module is disposed on the chassis and includes at least a condenser lens. At least two flanges are respectively formed on two sides of the condenser lens, the first positioning part includes a plurality of slots corresponding to the flanges, and the flanges are inserted into the slots to position the light source module on the chassis. The light combination module is disposed on the chassis and includes at least a plurality of dichroic mirrors. The second positioning part includes a plurality of positioning elements, and the dichroic mirrors are inserted into gaps formed by the positioning elements to position the light combination module on the chassis. The light-homogenizing module is disposed on the chassis and includes at least a lens array and a relay lens. At least two flanges are respectively formed on two sides of the lens array, at least two flanges are respectively formed on two sides of the relay lens, the third positioning part includes a plurality of slots corresponding to the flanges of the lens array and the relay lens, and the flanges are inserted into the slots to position the light-homogenizing module on the chassis. The projection lens module is disposed on the chassis and confined in the fourth positioning part. The projection lens module includes at least a lens assembly and at least one pillar structure penetrating through the lens assembly. The fourth positioning part includes at least one pilot hole corresponding to the pillar structure, and the pillar structure is inserted into the pilot hole to confine the projection lens module.

In one embodiment, the optical engine for a projector further includes at least one alignment pin penetrating through the light source module and inserted into the chassis.

In one embodiment, the positioning elements includes a plurality of positioning walls and a plurality of positioning bumps. At least one first gap is formed between the positioning walls, at least one second gap is formed between the positioning walls and the positioning bumps, and the dichroic mirrors are inserted into the first gap and the second gap.

In one embodiment, the positioning bumps includes first positioning bumps located on a first area and second positioning bumps located on a second area of the chassis, the first area is different to the second area, first sides of the dichroic mirrors lean against the first positioning bumps, and second sides of the dichroic mirrors lean against the second positioning bumps.

In one embodiment, the positioning elements are formed by molding and brought out by a single slide block.

In one embodiment, the slots are formed by stripping molding at a draft angle of zero degree.

In one embodiment, the pilot hole is defined by an arc-shaped base and a blanket structure formed on the arc-shaped base, the pillar structure is inserted into the pilot hole, and the blanket structure covers a part of the pillar structure.

In one embodiment, the volume of the optical engine is less than or equal to 7 cm³.

The embodiment or the embodiments of the invention may have at least one of the following advantages. According to the above embodiments, the thickness of the optical engine for a projector is formed by a space of light propagation and a thickness of an optical engine main body. Therefore, the overall thickness and volume are considerably reduced to miniaturize an assembled optical engine. Further, according to the above embodiments, a simple positioning mechanism is used to achieve accurate positioning and thus improve the production yield.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional miniaturized optical engine for a projector.

FIG. 2 shows a schematic diagram of another conventional miniaturized optical engine for a projector.

FIG. 3 shows a three-dimensional diagram illustrating an optical engine for a projector according to an embodiment of the invention.

FIGS. 4A and 4B show three-dimensional diagrams viewed from different sides of the optical engine shown in FIG. 3.

FIG. 5A shows another three-dimensional diagram of the optical engine shown in FIG. 3, and FIG. 5B is a cross-section cut along line P-P′ in FIG. 5A.

FIG. 6 shows another three-dimensional diagram illustrating an optical engine for a projector according to an embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

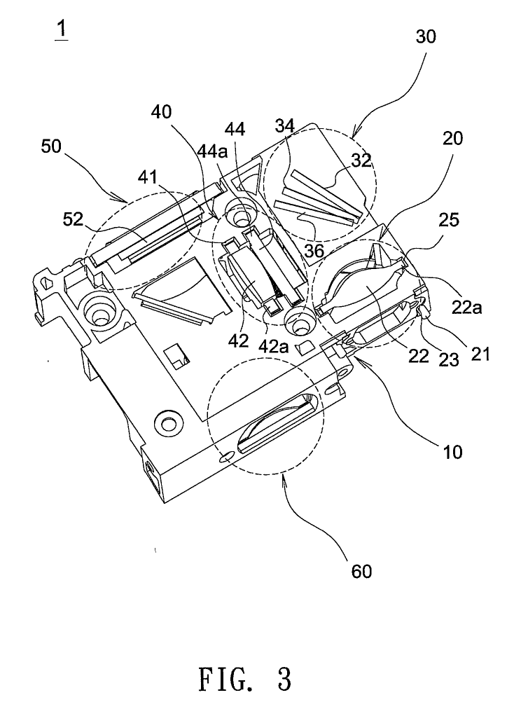

FIG. 3 shows a three-dimensional diagram illustrating an optical engine for a projector according to an embodiment of the invention, and members inside the optical engine are clearly seen in FIG. 3. Referring to FIG. 3, an optical engine 1 for a projector includes a chassis 10 and multiple optical members disposed on the chassis 10. The optical members may include a light source module 20, a light combination module 30, a light-homogenizing module 40, an imaging module 50 and a projection lens module 60. The light source module 20 is capable of emitting color light beams with different colors, and these color light beams are deflected by the light combination module 30 to propagate towards an identical direction. The light combination module 30 may include a blue dichroic mirror 32, a green dichroic mirror 34 and a red dichroic mirror 36. The light-homogenizing module 40 is capable of homogenizing these color light beams and may include a relay lens 42 and a lens array 44. The imaging module 50 may include a digital micromirror device (DMD) 52, and the imaging module 50 is capable of modulating the homogenized color light beams to form an image beam. The projection lens module 60 receives and then projects the image beam.

As shown in FIG. 3, light-emitting diode dies (not shown) of the light source module 20 are aligned with the aid of a charge coupled device (CCD) and fixed by glue dots. At least one alignment pin 21 penetrates through the light source module 20 and is inserted into a pilot hole 23 of the chassis 10 to position the light source module 20 on the chassis 10. Besides, the light source module 20 has a condenser lens 22, at least two flanges 22a are respectively formed on two sides of the condenser lens 22, and the chassis 10 has a plurality of slots 25 corresponding to the flanges 22a. Accordingly, when the condenser lens 22 is disposed on the chassis 10, the flanges 22a are inserted into the slots 25 to allow the light source module 20 to be accurately positioned on the chassis 10. Similarly, in the light-homogenizing module 40, at least two flanges 42a are respectively formed on two sides of the relay lens 42, and at least two flanges 44a are respectively formed on two sides of the lens array 44. The chassis 10 has a plurality of slots 41 corresponding to the flanges 42a and 44a. Hence, when the relay lens 42 and the lens array 44 are disposed on the chassis 10, the flanges 42a and 44a are inserted into the slots 41 to allow the light-homogenizing module 40 to be accurately positioned on the chassis 10. In one embodiment, the slots 25 and 41 are formed by stripping molding and striped from a plastic mold at a draft angle of zero degree.

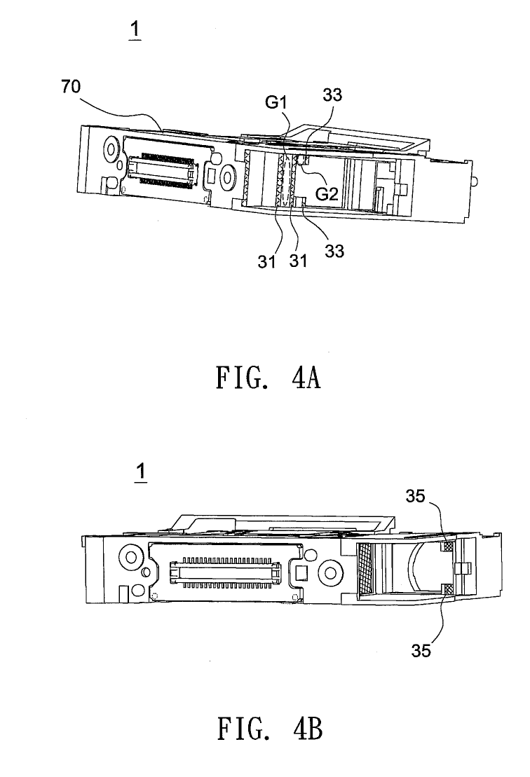

FIGS. 4A and 4B show three-dimensional diagrams viewed from different sides of the optical engine 1 shown in FIG. 3. Referring to FIGS. 4A and 4B, a copper heat sink 70 covers a part of the chassis 10, and a plurality of positioning walls 31 and a plurality of first positioning bumps 33 are formed on the chassis 10. First sides of the blue dichroic mirror 32, the green dichroic mirror 34 and the red dichroic mirror 36 are inserted into a gap G1 between two positioning walls 31 and a gap G2 between the positioning walls 31 and the first positioning bumps 33. Second sides (opposite the first sides) of the blue dichroic mirror 32, the green dichroic mirror 34 and the red dichroic mirror 36 lean against a plurality of second positioning bumps 35 formed on the chassis 10. The second positioning bumps 35 and the first positioning bumps 33 are located on different areas of the chassis 10. Thereby, all the dichroic mirrors 32, 34 and 36 are allowed to be accurately positioned on the chassis 10. In one embodiment, the positioning walls 31, the first positioning bumps 33 and the second positioning bumps 35 are formed by molding and brought out by a single slide block.

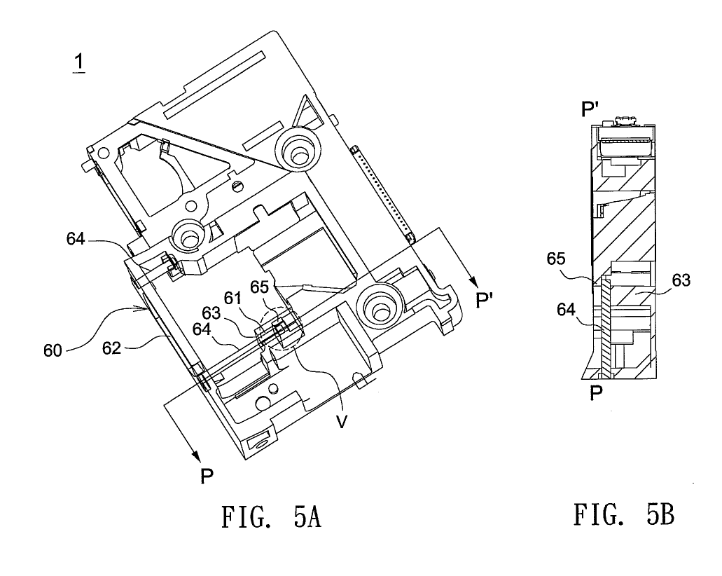

FIG. 5A shows another three-dimensional diagram of the optical engine 1 shown in FIG. 3, and FIG. 5B is a cross-section cut along line P-P′ in FIG. 5A. Referring to FIG. 5A, the projection lens module 60 includes a lens unit 62 and two pillar structures 64 penetrating through two sides of the lens unit 62, and the chassis 10 has a plurality of pilot holes 61 corresponding to the pillar structures 64. The pilot hole 61 is defined by an arc-shaped base 63 and a blanket structure 65 formed on the arc-shaped base 63. The pillar structures 64 are inserted into the pilot holes 61, and the blanket structure 65 covers a front end (the overlapping portion V shown in FIG. 5A) of each pillar structure 64 to prevent the front end of the pillar structure 64 from lifting during assembly. Such configuration facilitates positioning of members during assembly and thus enhances the produce yield.

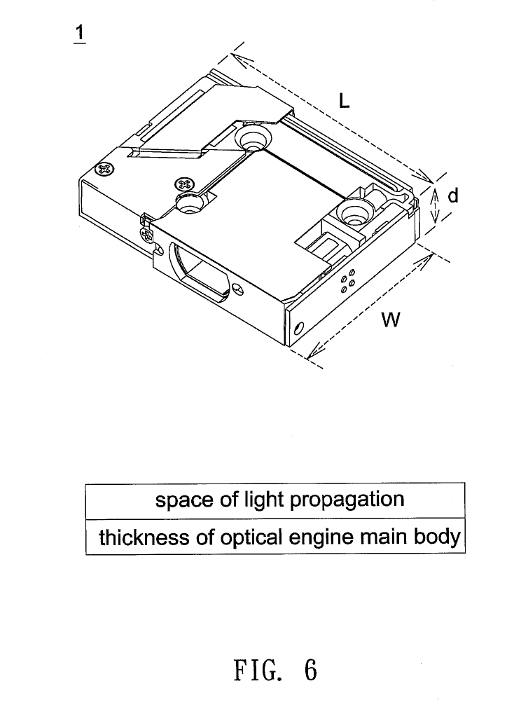

According to the above embodiments, as shown in FIG. 6, the thickness of optical engine 1 for a projector is formed by a space of light propagation and a thickness of an optical engine main body. Therefore, the entire volume of the optical engine 1 is considerably reduced. According to the above design, the volume of an assembled optical engine is allowed to be smaller than or equal to 7 cm³. In one embodiment, an assembled optical engine 1 has a length L of 30.6 mm, a width W of 23.76 mm, a thickness d of 5.8 mm, and thus a volume of 4.2 cm³.

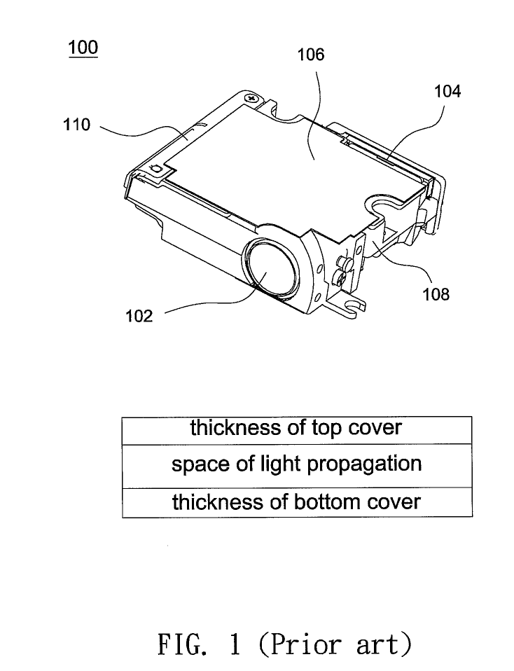

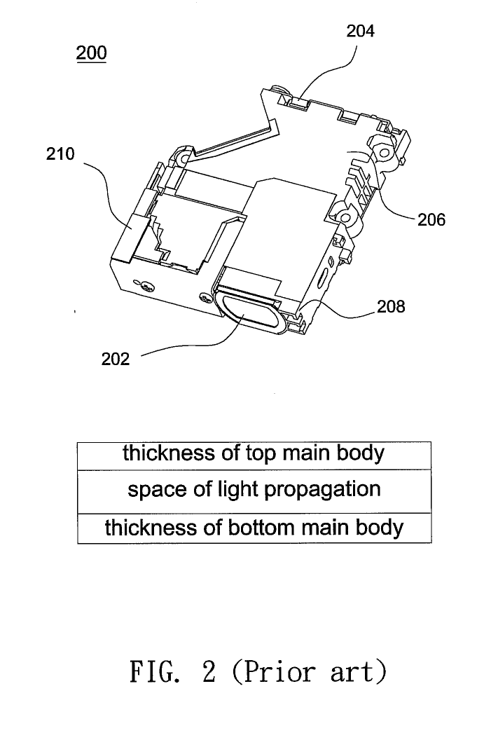

The embodiment or the embodiments of the invention may have at least one of the following advantages. According to the above embodiments, the overall thickness and volume, compared with prior designs, are considerably reduced to miniaturize an assembled optical engine. For example, the conventional optical engine 100 shown in FIG. 1 has a thickness d of 10.6 mm and a volume of 12 cm³, and the conventional optical engine 200 shown in FIG. 2 has a thickness d of 8 mm and a volume of 10 cm³. However, the volume of an assembled optical engine according to the above embodiments is reduced to 4.2 cm³. Further, according to the above embodiments, a simple positioning mechanism is used to achieve accurate positioning and thus improve the production yield.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding elements. These terms are not used to set up the upper limit or lower limit of the number of bumps.

What is claimed is:

1. An optical engine for a projector, comprising:
a chassis having at least a first positioning part, a second positioning part, a third positioning part and a fourth positioning part;
a light source module disposed on the chassis and comprising at least a condenser lens, wherein at least two flanges are respectively formed on two sides of the condenser lens, the first positioning part comprises a plurality of slots corresponding to the flanges, and the flanges are inserted into the slots to position the light source module on the chassis;
a light combination module disposed on the chassis and comprising a plurality of dichroic mirrors, wherein the second positioning part comprises a plurality of positioning elements, and the dichroic mirrors are inserted into gaps formed by the positioning elements to position the light combination module on the chassis;
a light-homogenizing module disposed on the chassis and comprising at least a lens array and a relay lens, wherein at least two flanges are respectively formed on two sides of the lens array, at least two flanges are respectively formed on two sides of the relay lens, the third positioning part comprises a plurality of slots corresponding to the flanges of the lens array and the relay lens, and the flanges of the lens array and the relay lens are inserted into the slots to position the light-homogenizing module on the chassis; and
a projection lens module disposed on the chassis and confined in the fourth positioning part, wherein the projection lens module comprises at least a lens unit and at least one pillar structure penetrating through the lens unit, the fourth positioning part comprises at least one pilot hole corresponding to the pillar structure, and the pillar structure is inserted into the pilot hole to confine the projection lens module.

2. The optical engine for a projector as claimed in claim 1, further comprising at least one alignment pin penetrating through the light source module and inserted into the chassis.

3. The optical engine for a projector as claimed in claim 1, wherein the positioning elements comprises a plurality of positioning walls and a plurality of positioning bumps.

4. The optical engine for a projector as claimed in claim 3, wherein at least one first gap is formed between the positioning walls, at least one second gap is formed between the positioning walls and the positioning bumps, and the dichroic mirrors are inserted into the first gap and the second gap.

5. The optical engine for a projector as claimed in claim 3, wherein the positioning bumps comprises first positioning bumps located on a first area and second positioning bumps located on a second area of the chassis, the first area is different to the second area, first sides of the dichroic mirrors lean against the first positioning bumps, and second sides of the dichroic mirrors lean against the second positioning bumps.

6. The optical engine for a projector as claimed in claim 1, wherein the positioning elements are formed by molding and brought out by a single slide block.

7. The optical engine for a projector as claimed in claim 1, wherein the slots are formed by stripping molding at a draft angle of zero degree.

8. The optical engine for a projector as claimed in claim 1, wherein the pilot hole is defined by an arc-shaped base and a blanket structure formed on the arc-shaped base, the pillar structure is inserted into the pilot hole, and the blanket structure covers a part of the pillar structure.

9. The optical engine for a projector as claimed in claim 1, wherein the projection lens module comprises two pillar structures penetrating through two sides of the lens unit.

10. The optical engine for a projector as claimed in claim 1, further comprising a copper heat sink covering a part of the chassis.

11. The optical engine for a projector as claimed in claim 1, wherein the volume of the optical engine is smaller than or equal to 7 cm³.
